(19) United States
(12) Patent Application Publication
(10) Pub. No.: US 2017/0021678 A1
(43) Pub. Date: Jan. 26, 2017

(54) Tire Construction With Discontinuous Body Ply Configuration

(71) Applicant: Bridgestone Americas Tire Operations, LLC, Nashville, TN (US)

(72) Inventors: Benjamin R. Rethmel, Doylestown, OH (US); Brian D. Steenwyk, Uniontown, OH (US); Bradley J. Harris, New London, OH (US); Anoop G. Varghese, Fairlawn, OH (US); Dennis W. Snyder, Uniontown, OH (US); Hans R. Dorfi, Akron, OH (US); Samuel O. Givens, Copley, OH (US)

(21) Appl. No.: 15/113,060

(22) PCT Filed: Jan. 27, 2015
(86) PCT No.: PCT/US15/13046

§ 371 Date: Jul. 21, 2016

Related U.S. Application Data
(60) Provisional application No. 61/936,609, filed on Feb. 6, 2014.

(51) Int. Cl. B60C 15/00; B60C 9/04; B60C 9/02

(52) U.S. Cl. CPC B60C 15/0036; B60C 9/0207; B60C 9/04; B60C 2009/0408

(57) ABSTRACT

Various embodiments of a tire having a discontinuous body ply configuration are disclosed.

### BACKGROUND

In the construction of a tire, one of the many key elements is the body ply. The body ply, which typically comprises reinforcement cord and rubber skim, wraps around the bead wire bundle (creating a “turnup” portion), passes radially across the tire, and wraps around the bead bundle on the opposite side (creating another “turnup” portion). The body ply provides strength to contain the air pressure within the tire and provides for sidewall impact resistance.

However, the location of the ending of the body ply, which may include a turnup portion, is limited by the overall width of the body ply. Conventional tire manufacturing processes and conventional tire building machines are configured to handle body plies up to a certain width, which may not permit placement of the ending of the body ply in a desired position.

What is needed is a discontinuous body ply that is configured to allow body ply endings in a turnup portion to extend further radially outwardly as compared to a conventional continuous body ply.

### SUMMARY

In one embodiment, a pneumatic tire is provided, the pneumatic tire comprising: a crown portion; a first bead portion oriented on a first side of the tire; a first sidewall oriented on the first side of the tire; a second bead portion oriented on a second side of the tire; a second sidewall oriented on the second side of the tire; a first part of a first discontinuous body ply extending about the first bead portion, along the first sidewall, and terminating at a point within the crown portion; and a second part of the first discontinuous body ply extending about the second bead portion, along the second sidewall, and terminating at a point within the crown portion; wherein the first part of the first discontinuous body ply and the second part of the first discontinuous body ply overlap within the crown portion; and wherein the first part of the first discontinuous body ply and the second part of the first discontinuous body ply are joined in a splice within the crown portion.

In another embodiment, a pneumatic tire is provided, the pneumatic tire comprising: a crown portion; a first bead portion oriented on a first side of the tire; a first sidewall oriented on the first side of the tire; a first shoulder oriented on the first side of the tire; a second bead portion oriented on a second side of the tire; a second sidewall oriented on the second side of the tire; a second shoulder oriented on the second side of the tire; a first part of a first discontinuous body ply extending about the first bead portion, along the first sidewall, and terminating at a point within the crown portion; a second part of the first discontinuous body ply extending about the second bead portion, along the second sidewall, and terminating at a point within the crown portion; a first part of a second discontinuous body ply extending about the first bead portion, along the first sidewall, and terminating at a point within at least one of the first shoulder and the crown portion; and a second part of the second discontinuous body ply extending about the second bead portion, along the second sidewall, and terminating at a point within at least one of the second shoulder and the crown portion; wherein the first part of the first discontinuous body ply and the second part of the first discontinuous body ply overlap within the crown portion; and wherein the first part of the first discontinuous body ply and the second part of the first discontinuous body ply are joined in a splice within the crown portion.

In another embodiment, a pneumatic tire is provided, the pneumatic tire comprising: a crown portion; a first bead portion oriented on a first side of the tire; a first sidewall oriented on the first side of the tire; a first shoulder oriented on the first side of the tire; a second bead portion oriented on a second side of the tire; a second sidewall oriented on the second side of the tire; a second shoulder oriented on the second side of the tire; a first part of a first discontinuous body ply extending about the first bead portion, along the first sidewall, and terminating at a point within the crown portion, wherein the first part of the first discontinuous body ply includes a first turnup portion, and wherein the first turnup portion terminates in at least one of the first sidewall, the first shoulder, and the crown portion; and a second part of the first discontinuous body ply extending about the second bead portion, along the second sidewall, and terminating at a point within the crown portion, wherein the second part of the first discontinuous body ply includes a second turnup portion, and wherein the second turnup portion terminates in at least one of the second sidewall, the second shoulder, and the crown portion; wherein the first part of the first discontinuous body ply and the second part of the first discontinuous body ply overlap within the crown portion; and wherein the first part of the first discontinuous body ply and the second part of the first discontinuous body ply are joined in a splice within the crown portion.

### BRIEF DESCRIPTION OF THE DRAWINGS

The accompanying figures, which are incorporated in and constitute a part of the specification, illustrate various example constructions, and are used merely to illustrate various example embodiments. In the figures, like elements bear like reference numerals.

FIG. 1 illustrates a cross-sectional view of an example arrangement of a tire having a discontinuous body ply configuration.

FIG. 2 illustrates a cross-sectional view of an example arrangement of a tire having a discontinuous body ply configuration.

FIG. 3 illustrates a cross-sectional view of an example arrangement of a tire having a discontinuous body ply configuration.

FIG. 4 illustrates a cross-sectional view of a prior art tire construction.

### DETAILED DESCRIPTION

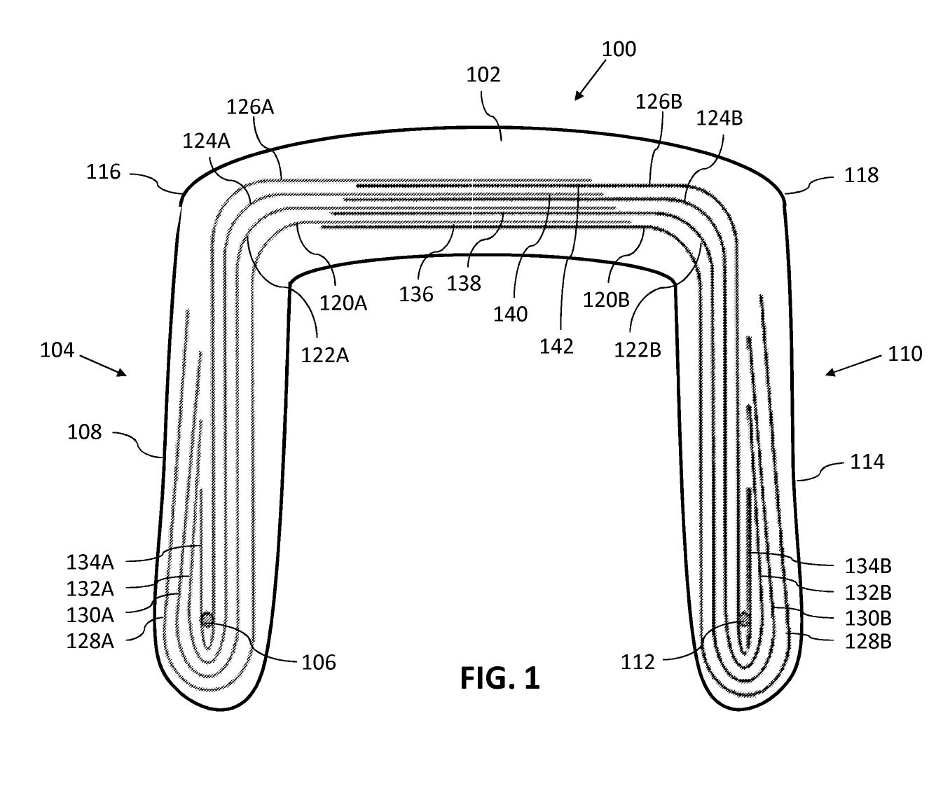

FIG. 1 illustrates a cross-sectional view of an example arrangement of a tire 100 having a discontinuous body ply configuration. Tire 100 may comprise a crown portion 102 and a first side 104. A first bead portion 106 may be oriented on first side 104. A first sidewall 108 may be oriented on first side 104. Tire 100 may comprise a second side 110. A second bead portion 112 may be oriented on second side 110. A second sidewall 114 may be oriented on second side 110. In one embodiment, tire 100 may comprise a first shoulder 116 oriented on first side 104, and a second shoulder 118 oriented on second side 110.

In one embodiment, tire 100 may comprise a first part of a first discontinuous body ply 120A and a second part of the first discontinuous body ply 120B. Tire 100 may comprise a first part of a second discontinuous body ply 122A and a second part of the second discontinuous body ply 122B. Tire 100 may comprise a first part of a third discontinuous body ply 124A and a second part of the third discontinuous body ply 124B. Tire 100 may comprise a first part of a fourth discontinuous body ply 126A and a second part of the fourth discontinuous body ply 126B. It is contemplated that tire 100 can have any number of discontinuous body plies. Additionally, it is contemplated that tire 100 can have any number of parts of a discontinuous body ply (i.e., two or more parts).

In one embodiment, any of first parts 120A, 122A, 124A, and 126A may extend about first bead portion 106, along first sidewall 108, along first shoulder 116, and terminate in crown portion 102. Any of first parts 120A, 122A, 124A, and 126A may extend about first bead portion 106, along first sidewall 108, along first shoulder 116, across crown portion 102, and terminate in at least one of second shoulder 118 and second sidewall 114. Any of first parts 120A, 122A, 124A, and 126A may extend about first bead portion 106, and terminate in at least one of first sidewall 108 and first shoulder 116.

In one embodiment, any of second parts 120B, 122B, 124B, and 126B may extend about second bead portion 112, along second sidewall 114, along second shoulder 118, and terminate in crown portion 102. Any of second parts 120B, 122B, 124B, and 126B may extend about second bead portion 112, along second sidewall 114, along second shoulder 118, across crown portion 102, and terminate in at least one of first shoulder 116 and first sidewall 108. Any of second parts 120B, 122B, 124B, and 126B may extend about second bead portion 112, and terminate in at least one of second sidewall 110 and second shoulder 118.

In one embodiment, first part of first discontinuous body ply 120A may comprise a turnup portion 128A. Second part of first discontinuous body ply 120B may comprise a turnup portion 128B. First part of second discontinuous body ply 122A may comprise a turnup portion 130A. Second part of second discontinuous body ply 122B may comprise a turnup portion 130B. First part of third discontinuous body ply 124A may comprise a turnup portion 132A. Second part of third discontinuous body ply 124B may comprise a turnup portion 132B. First part of fourth discontinuous body ply 126A may comprise a turnup portion 134A. Second part of fourth discontinuous body ply 126B may comprise a turnup portion 134B.

In one embodiment, at least one of turnup portions 128A, 130A, 132A, and 134A may terminate in at least one of first bead portion 106, first sidewall 108, first shoulder 116, and crown portion 102. It is contemplated that any of turnup portions 128A, 130A, 132A, and 134A may be oriented at different heights or the same height.

In one embodiment, at least one of turnup portions 128B, 130B, 132B, and 134B may terminate in at least one of second bead portion 112, second sidewall 114, second shoulder 118, and crown portion 102. It is contemplated that any of turnup portions 128B, 130B, 132B, and 134B may be oriented at different heights or the same height.

In one embodiment, first part of first discontinuous body ply 120A may overlap with second part of first discontinuous body ply 120B in crown portion 102. First part of first discontinuous body ply 120A may be joined in a splice 136 with second part of first discontinuous body ply 120B. First part of second discontinuous body ply 122A may overlap with second part of second discontinuous body ply 122B in crown portion 102. First part of second discontinuous body ply 122A may be joined in a splice 138 with second part of second discontinuous body ply 122B. First part of third discontinuous body ply 124A may overlap with second part of third discontinuous body ply 124B in crown portion 102. First part of third discontinuous body ply 124A may be joined in a splice 140 with second part of third discontinuous body ply 124B. First part of fourth discontinuous body ply 126A may overlap with second part of fourth discontinuous body ply 126B in crown portion 102. First part of fourth discontinuous body ply 126A may be joined in a splice 142 with second part of fourth discontinuous body ply 126B.

Any of splices 136, 138, 140, and 142 may be oriented in crown portion 102. Splices 136, 138, 140, and 142 may be effected by any of a variety of methods, including through use of an adhesive layer, through stitching at least a portion of the components, through the application of a pressure, and the like. Splices 136, 138, 140, and 142 may extend at least a portion of, if not the entire, width of the overlap of first parts 120A, 122A, 124A, and 126A with second parts 120B, 122B, 124B, and 126B, respectively.

Tire 100 may comprise a pneumatic tire. In one embodiment, tire 100 is a pneumatic tire designed for application to a vehicle. In another embodiment, tire 100 is a pneumatic tire designed for application to a road vehicle. In one embodiment, tire 100 is a non-directional tire, wherein tire 100 is configured to be mounted on a vehicle without a specified forward rolling direction. In another embodiment, tire 100 is a uni-directional tire, wherein tire 100 is configured to be mounted on a vehicle with a specified forward rolling direction.

In one embodiment, any of first discontinuous ply 120, second discontinuous ply 122, third discontinuous ply 124, and fourth discontinuous ply 126 may be configured to achieve greater total width of discontinuous ply 120, 122, 124, and 126. Any of first discontinuous ply 120, second discontinuous ply 122, third discontinuous ply 124, and fourth discontinuous ply 126 may be configured to allow turnup portions 128, 130, 132, and 134, respectively, to have greater heights, wherein height is measured radially from a line extending through tire 100's axis of rotation. Any of first discontinuous ply 120, second discontinuous ply 122, third discontinuous ply 124, and fourth discontinuous ply 126 may be configured to decrease a tire mass that is associated with use of the same number of conventional continuous plies.

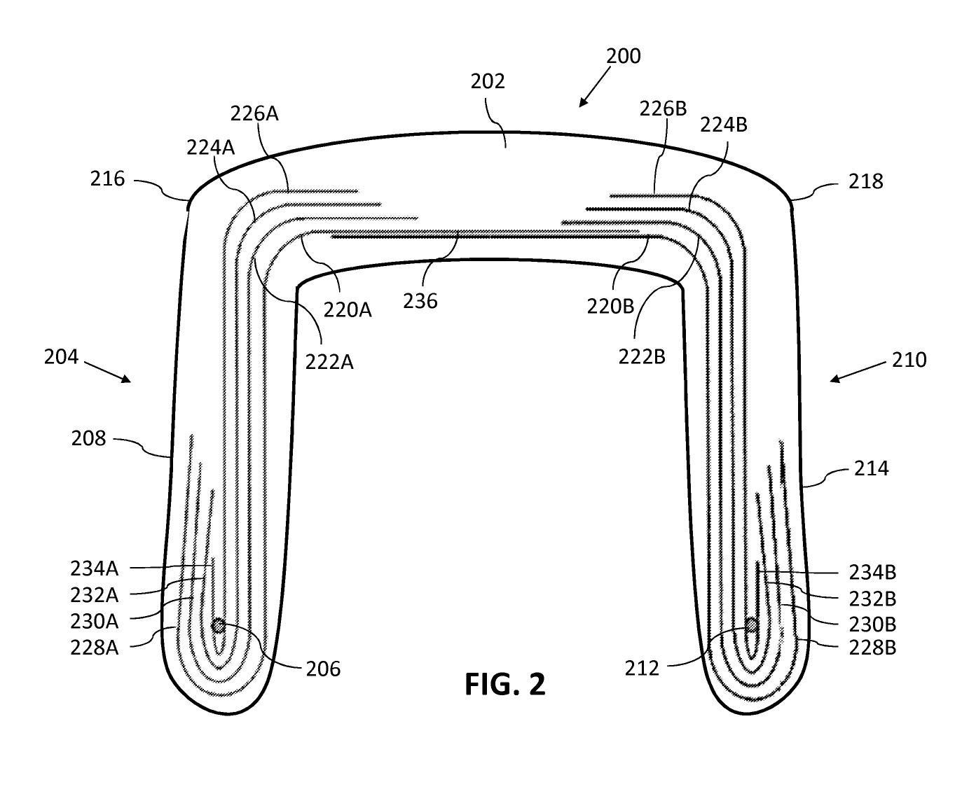

FIG. 2 illustrates a cross-sectional view of an example arrangement of a tire 200 having a discontinuous body ply configuration. Tire 200 may comprise a crown portion 202 and a first side 204. A first bead portion 206 may be oriented on first side 204. A first sidewall 208 may be oriented on first side 204. Tire 200 may comprise a second side 210. A second bead portion 212 may be oriented on second side 210. A second sidewall 214 may be oriented on second side 210. In one embodiment, tire 200 may comprise a first shoulder 216 oriented on first side 204, and a second shoulder 218 oriented on second side 210.

In one embodiment, tire 200 may comprise a first part of a first discontinuous body ply 220A and a second part of the first discontinuous body ply 220B. Tire 200 may comprise a first part of a second discontinuous body ply 222A and a second part of the second discontinuous body ply 222B. Tire 200 may comprise a first part of a third discontinuous body ply 224A and a second part of the third discontinuous body ply 224B. Tire 200 may comprise a first part of a fourth discontinuous body ply 226A and a second part of the fourth discontinuous body ply 226B. It is contemplated that tire 200 can have any number of discontinuous body plies. Additionally, it is contemplated that tire 200 can have any number of parts of a discontinuous body ply (i.e., two or more parts).

In one embodiment, first part of first discontinuous body ply 220A may comprise a turnup portion 228A. Second part of first discontinuous body ply 220B may comprise a turnup portion 228B. First part of second discontinuous body ply 222A may comprise a turnup portion 230A. Second part of second discontinuous body ply 222B may comprise a turnup portion 230B. First part of third discontinuous body ply 224A may comprise a turnup portion 232A. Second part of third discontinuous body ply 224B may comprise a turnup portion 232B. First part of fourth discontinuous body ply 226A may comprise a turnup portion 234A. Second part of fourth discontinuous body ply 226B may comprise a turnup portion 234B.

In one embodiment, at least one of turnup portions 228A, 228B, 230A, 230B, 232A, 232B, 234A, and 234B may terminate in at least one of first bead portion 206, second bead portion 212, first sidewall 208, second sidewall 214, first shoulder 216, second shoulder 218, and crown portion 202, respectively. It is contemplated that any of turnup portions 228A, 228B, 230A, 230B, 232A, 232B, 234A, and 234B may be oriented at different heights or the same height, wherein height is measured radially from a line extending through tire 200's axis of rotation.

In one embodiment, first part of first discontinuous body ply 220A may overlap with second part of first discontinuous body ply 220B in crown portion 102. First part of first discontinuous body ply 220A may be joined in a splice 236 with second part of first discontinuous body ply 220B.

First part of second discontinuous body ply 222A may terminate a distance from second part of second discontinuous body ply 222B in crown portion 202, thus creating a gap. First part of third discontinuous body ply 224A may terminate a distance from second part of third discontinuous body ply 224B in crown portion 202, thus creating a gap. First part of fourth discontinuous body ply 226A may terminate a distance from second part of fourth discontinuous body ply 226B in crown portion 202, thus creating a gap. It is contemplated that any number of discontinuous body plies may overlap, or create a gap, as necessary or practical to achieve the desired tire performance characteristics. That is, in one embodiment, one or more discontinuous ply may overlap and include a splice, and one or more discontinuous ply may terminate a distance from one another and create a gap.

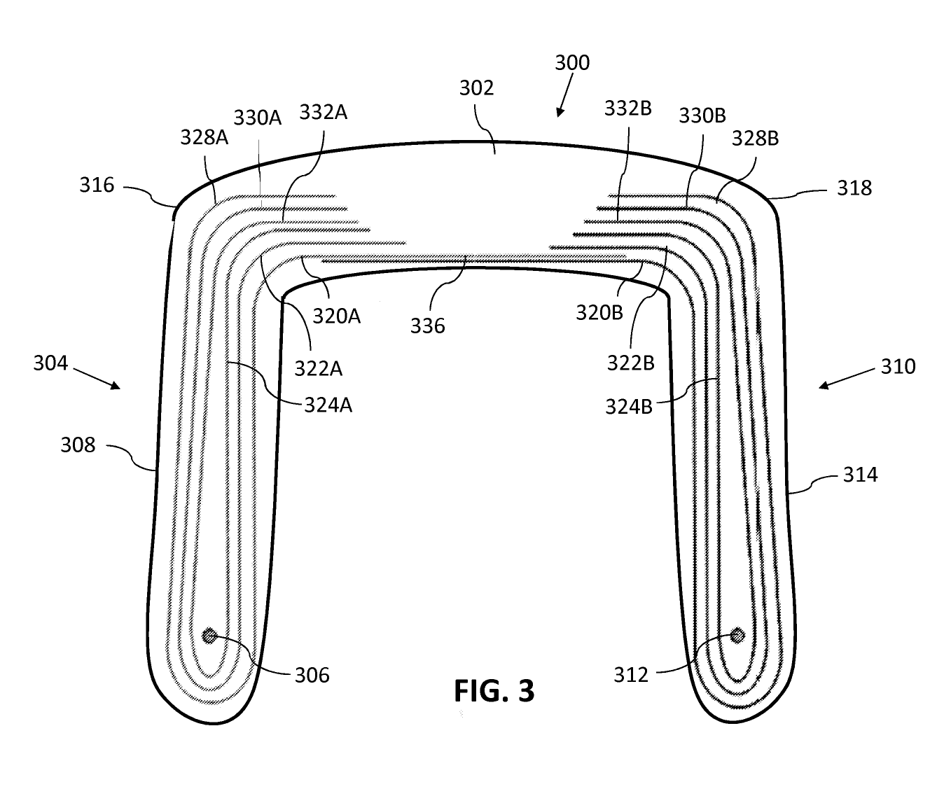

FIG. 3 illustrates a cross-sectional view of an example arrangement of a tire 300 having a discontinuous body ply configuration. Tire 300 may comprise a crown portion 302 and a first side 304. A first bead portion 306 may be oriented on first side 304. A first sidewall 308 may be oriented on first side 304. Tire 300 may comprise a second side 310. A second bead portion 312 may be oriented on second side 310. A second sidewall 314 may be oriented on second side 310. In one embodiment, tire 300 may comprise a first shoulder 316 oriented on first side 304, and a second shoulder 318 oriented on second side 310.

In one embodiment, tire 300 may comprise a first part of a first discontinuous body ply 320A and a second part of the first discontinuous body ply 320B. Tire 300 may comprise a first part of a second discontinuous body ply 322A and a second part of the second discontinuous body ply 322B. Tire 300 may comprise a first part of a third discontinuous body ply 324A and a second part of the third discontinuous body ply 324B. It is contemplated that tire 300 can have any number of discontinuous body plies. Additionally, it is contemplated that tire 300 can have any number of parts of a discontinuous body ply (i.e., two or more parts).

In one embodiment, first part of first discontinuous body ply 320A may comprise a turnup portion 328A. Second part of first discontinuous body ply 320B may comprise a turnup portion 328B. First part of second discontinuous body ply 322A may comprise a turnup portion 330A. Second part of second discontinuous body ply 322B may comprise a turnup portion 330B. First part of third discontinuous body ply 324A may comprise a turnup portion 332A. Second part of third discontinuous body ply 324B may comprise a turnup portion 332B.

In one embodiment, at least one of turnup portions 328A, 328B, 330A, 330B, 332A, 332B, may terminate in at least one of first shoulder 316, second shoulder 318, and crown portion 302, respectively. It is contemplated that any of turnup portions 328A, 328B, 330A, 330B, 332A, 332B, may be oriented at different heights or the same height, wherein height is measured radially from a line extending through tire 300's axis of rotation.

In one embodiment, first part of first discontinuous body ply 320A may overlap with second part of first discontinuous body ply 320B in crown portion 302. First part of first discontinuous body ply 320A may be joined in a splice 336 with second part of first discontinuous body ply 320B.

First part of second discontinuous body ply 322A may terminate a distance from second part of second discontinuous body ply 322B in crown portion 302, thus creating a gap. First part of third discontinuous body ply 324A may terminate a distance from second part of third discontinuous body ply 324B in crown portion 302, thus creating a gap. It is contemplated that any number of discontinuous body plies may overlap, or create a gap, as necessary or practical to achieve the desired tire performance characteristics. That is, in one embodiment, one or more discontinuous ply may overlap and include a splice, and one or more discontinuous ply may terminate a distance from one another and create a gap.

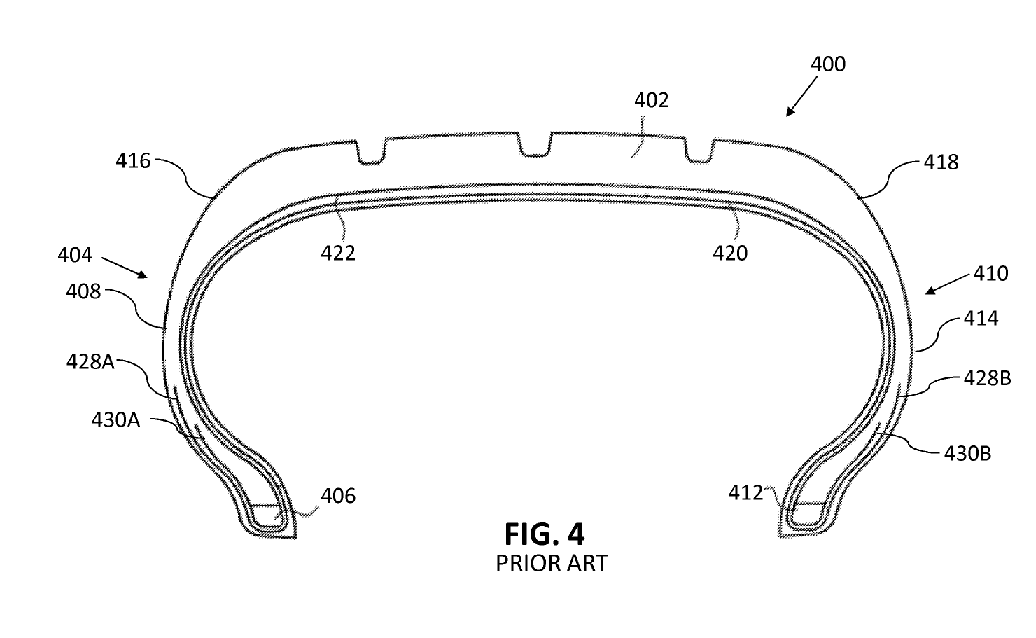

FIG. 4 illustrates a cross-sectional view of a prior art tire 400 having a continuous body ply configuration. Tire 400 consists of a crown portion 402, a first side 404, a first bead portion 406, a first sidewall 408, a second side 410, a second bead portion 412, a second sidewall 414, a first shoulder 416, a second shoulder 418, a first continuous body ply 420, and a second continuous body ply 422. First continuous body ply 420 includes turnup portions 428A and 428B. Second continuous body ply 422 includes turnup portions 430A and 430B.

As illustrated in FIG. 4, first continuous body ply 420 and second continuous body ply 422 extend across crown portion 402 without a splice or gap.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A pneumatic tire, comprising:
a crown portion;
a first bead portion oriented on a first side of the tire;
a first sidewall oriented on the first side of the tire;
a second bead portion oriented on a second side of the tire;
a second sidewall oriented on the second side of the tire;
a first part of a first discontinuous body ply extending about the first bead portion, along the first sidewall, and terminating at a point within the crown portion; and
a second part of the first discontinuous body ply extending about the second bead portion, along the second sidewall, and terminating at a point within the crown portion;
wherein the first part of the first discontinuous body ply and the second part of the first discontinuous body ply overlap within the crown portion; and
wherein the first part of the first discontinuous body ply and the second part of the first discontinuous body ply are joined in a splice within the crown portion.

2. The pneumatic tire of claim 1, further comprising:
a first shoulder oriented on the first side of the tire;
a second shoulder oriented on the second side of the tire;
a first part of a second discontinuous body ply extending about the first bead portion, along the first sidewall, and terminating at a point within at least one of the first shoulder and the crown portion; and
a second part of the second discontinuous body ply extending about the second bead portion, along the second sidewall, and terminating at a point within at least one of the second shoulder and the crown portion.

3. The pneumatic tire of claim 2, wherein the first part of the second discontinuous body ply and the second part of the second discontinuous body ply do not overlap one another.

4. The pneumatic tire of claim 3, wherein the first part of the second discontinuous body ply and the second part of the second discontinuous body ply create a gap in the crown portion.

5. The pneumatic tire of claim 1,
wherein the first part of the first discontinuous body ply includes a first turnup portion, and wherein the first turnup portion terminates in at least one of the first sidewall, the first shoulder, and the crown portion; and
wherein the second part of the first discontinuous body ply includes a second turnup portion, and wherein the second turnup portion terminates in at least one of the second sidewall, the second shoulder, and the crown portion.

6. The pneumatic tire of claim 1, wherein the splice includes at least one of an adhesive layer and a stitched portion.

7. A pneumatic tire, comprising:
a crown portion;
a first bead portion oriented on a first side of the tire;
a first sidewall oriented on the first side of the tire;
a first shoulder oriented on the first side of the tire;
a second bead portion oriented on a second side of the tire;
a second sidewall oriented on the second side of the tire;
a second shoulder oriented on the second side of the tire;
a first part of a first discontinuous body ply extending about the first bead portion, along the first sidewall, and terminating at a point within the crown portion;
a second part of the first discontinuous body ply extending about the second bead portion, along the second sidewall, and terminating at a point within the crown portion;
a first part of a second discontinuous body ply extending about the first bead portion, along the first sidewall, and terminating at a point within at least one of the first shoulder and the crown portion; and
a second part of the second discontinuous body ply extending about the second bead portion, along the second sidewall, and terminating at a point within at least one of the second shoulder and the crown portion;
wherein the first part of the first discontinuous body ply and the second part of the first discontinuous body ply overlap within the crown portion; and
wherein the first part of the first discontinuous body ply and the second part of the first discontinuous body ply are joined in a splice within the crown portion.

8. The pneumatic tire of claim 7, wherein the first part of the second discontinuous body ply and the second part of the second discontinuous body ply do not overlap one another.

9. The pneumatic tire of claim 8, wherein the first part of the second discontinuous body ply and the second part of the second discontinuous body ply create a gap in the crown portion.

10. The pneumatic tire of claim 7,
wherein the first part of the first discontinuous body ply includes a first turnup portion, and wherein the first turnup portion terminates in at least one of the first sidewall, the first shoulder, and the crown portion; and
wherein the second part of the first discontinuous body ply includes a second turnup portion, and wherein the second turnup portion terminates in at least one of the second sidewall, the second shoulder, and the crown portion.

11. The pneumatic tire of claim 7,
wherein the first part of the second discontinuous body ply includes a third turnup portion, and wherein the third turnup portion terminates in at least one of the first sidewall, the first shoulder, and the crown portion; and
wherein the second part of the second discontinuous body ply includes a fourth turnup portion, and wherein the fourth turnup portion terminates in at least one of the second sidewall, the second shoulder, and the crown portion.

12. The pneumatic tire of claim 7, wherein the splice includes at least one of an adhesive layer and a stitched portion.

13. A pneumatic tire, comprising:
a crown portion;
a first bead portion oriented on a first side of the tire;
a first sidewall oriented on the first side of the tire;
a first shoulder oriented on the first side of the tire;
a second bead portion oriented on a second side of the tire;
a second sidewall oriented on the second side of the tire;
a second shoulder oriented on the second side of the tire;
a first part of a first discontinuous body ply extending about the first bead portion, along the first sidewall, and terminating at a point within the crown portion,
wherein the first part of the first discontinuous body ply includes a first turnup portion, and wherein the first turnup portion terminates in at least one of the first sidewall, the first shoulder, and the crown portion; and
a second part of the first discontinuous body ply extending about the second bead portion, along the second sidewall, and terminating at a point within the crown portion,
wherein the second part of the first discontinuous body ply includes a second turnup portion, and wherein the second turnup portion terminates in at least one of the second sidewall, the second shoulder, and the crown portion;
wherein the first part of the first discontinuous body ply and the second part of the first discontinuous body ply overlap within the crown portion; and
wherein the first part of the first discontinuous body ply and the second part of the first discontinuous body ply are joined in a splice within the crown portion.

14. The pneumatic tire of claim 13, further comprising:
a first part of a second discontinuous body ply extending about the first bead portion, along the first sidewall, and terminating at a point within at least one of the first shoulder and the crown portion; and
a second part of the second discontinuous body ply extending about the second bead portion, along the second sidewall, and terminating at a point within at least one of the second shoulder and the crown portion.

15. The pneumatic tire of claim 14,
wherein the first part of the second discontinuous body ply includes a third turnup portion, and wherein the third turnup portion terminates in at least one of the first sidewall, the first shoulder, and the crown portion; and
wherein the second part of the second discontinuous body ply includes a fourth turnup portion, and wherein the fourth turnup portion terminates in at least one of the second sidewall, the second shoulder, and the crown portion.

16. The pneumatic tire of claim 14, wherein the first part of the second discontinuous body ply and the second part of the second discontinuous body ply do not overlap one another.

17. The pneumatic tire of claim 16, wherein the first part of the second discontinuous body ply and the second part of the second discontinuous body ply create a gap in the crown portion.

18. The pneumatic tire of claim 13, wherein the splice includes at least one of an adhesive layer and a stitched portion.
